(19) United States
(12) Patent Application Publication
(10) Pub. No.: US 2026/0280693 A1
(43) Pub. Date: Sep. 17, 2026

(54) Methods and Apparatuses for Multi-Modal Use of a Satellite in a Satellite Communications System

(71) Applicant: Viasat, Inc., Carlsbad, CA (US)

(72) Inventor: Kenneth V. Buer, Bluff City, TN (US)

(21) Appl. No.: 19/168,944

(22) PCT Filed: Mar. 28, 2024
(86) PCT No.: PCT/US2024/021854

§ 371 Date: Sep. 25, 2025

Related U.S. Application Data
(60) Provisional application No. 63/493,119, filed on Mar. 30, 2023.

(51) Int. Cl. H04B 7/204; H04B 7/06; H04B 7/08; H04B 7/185

(52) U.S. Cl. CPC H04B 7/2041; H04B 7/0617; H04B 7/086; H04B 7/18515; H04B 7/18517; H04B 7/18519

(57) ABSTRACT

A satellite communications system (SCS) operates modally, with modal operation involving selective operation in a first forward service mode or a second forward service mode. Whereas the first forward service mode involves ground based beamforming, the second forward service mode does not. Hence, feeder link bandwidth consumed for GBBF in the first forward service mode may be used for increased data bandwidth in the second forward service mode. Modal operation extends to first and second return service modes, respectively complementing the first and second forward service modes.

### TECHNICAL FIELD

Disclosed techniques provide for modal operation of a satellite access node and an associated satellite, wherein a signal structure of feeder link and user link signals change as a function of operating mode.

### BACKGROUND

Ground based beamforming (GBBF) in the context of satellite communications system (SCSs) offers a number of advantages, not least the potential for reduction in complexity of the satellite payload. With GBBF in the forward direction, the ground network generates element signals corresponding to phased-array elements onboard the satellite to be used for the beamforming, with these element signals weighted. The weightings are calculated such that coherent transmission of the element signals from the onboard phased array antenna of the satellite produces far field superpositions-constructive and destructive wavefront combining-that result in the desired user beams.

In the return direction, the satellite receives user uplink signals impinging on the individual antenna elements in the same or another phased array antenna of the satellite, and returns these element signals to the ground network, for GBBF processing. That is, the return beams are formed in the ground network, in the signal processing domain.

While GBBF offers numerous advantages, such as the payload complexity reductions described above, GBBF consumes considerable feeder link bandwidth.

### SUMMARY

A satellite communications system (SCS) operates modally, with modal operation involving selective operation in a first forward service mode or a second forward service mode. Whereas the first forward service mode involves ground based beamforming, the second forward service mode does not. Hence, feeder link bandwidth consumed for GBBF in the first forward service mode may be used for increased data bandwidth in the second forward service mode. Modal operation extends to first and second return service modes, respectively complementing the first and second forward service modes.

One embodiment comprises a method of operation by a satellite in a SCS, where the method includes selectively operating the satellite in either a first forward service or a second forward service mode. The first forward service mode includes: receiving, via a first antenna system of the satellite, a first type of feeder uplink signal comprising a plurality of forward element signals stacked in frequency and corresponding to antenna elements in a phased array antenna included in a second antenna system of the satellite, the plurality of forward element signals weighted such that simultaneous transmission of the plurality of forward element signals as first user downlink signals from the phased array antenna results in far field formation of one or more first forward user beams, each first forward user beam having a corresponding first forward user beam coverage area and conveying traffic for one or more first user terminals that are in a population of first user terminals and are located in the corresponding first forward user beam coverage area; unstacking the plurality of forward element signals to a same downlink frequency via a feeder link payload of the satellite; and coupling the unstacked plurality of forward element signals to the phased array antenna via a first user link payload of the satellite, for transmission from the phased array antenna as the first user downlink signals and the resulting formation of the one or more first forward user beams.

The second forward service mode includes: receiving, via the first antenna system of the satellite, a second type of feeder uplink signal comprising one or more forward beam signals; and coupling the one or more forward beam signals to the first antenna system via a second user link payload of the satellite, for transmission from the first antenna system as one or more second user downlink signals, each second user downlink signal transmitted as a corresponding second forward user beam having a corresponding second forward user beam coverage area and conveying traffic for one or more second user terminals that are in a population of second user terminals and are located in the corresponding second forward user beam coverage area.

A related embodiment comprises a satellite configured for operation in a SCS. The satellite includes a first antenna system, a second antenna system, a feeder link payload associated with the first antenna system, a first user link payload associated with the second antenna system, a second user link payload associated with the first antenna system, and mode control circuitry configured to control configuration of the satellite for selective operation in either a first forward service mode or a second forward service mode. The first and second forward service modes are as described for the method immediately above.

Another embodiment comprises a method of operation by a satellite access node (SAN) in a SCS. The method includes the SAN selectively operating in either a first forward service mode or a second forward service mode.

The first forward service mode at the SAN includes: forming a first type of feeder uplink signal comprising a plurality of forward element signals stacked in frequency and corresponding to antenna elements in a phased array antenna of a satellite, the plurality of forward element signals weighted such that simultaneous transmission of the plurality of forward element signals as first user downlink signals from the phased array antenna results in far field formation of one or more first forward user beams, each first forward user beam having a corresponding forward user beam coverage area and conveying traffic for one or more first user terminals that are in a population of first user terminals and are located in the corresponding forward user beam coverage area; and transmitting the first type of feeder uplink signal for reception by the satellite.

The second forward service mode at the SAN includes: forming a second type of feeder uplink signal comprising one or more forward beam signals, each forward beam signal conveying traffic for one or more second user terminals in a corresponding second forward user beam coverage area; and transmitting the second type of feeder uplink signal for reception by the satellite and transmission of the one or more forward beam signals as one or more second user downlink signals.

A related embodiment comprises a SAN configured for operation in a SCS. The SAN includes transmitter circuitry and signal processing circuitry configured to operate either in the first forward service mode as described for the SAN immediately above, or in the second forward service mode as described for the SAN immediately above.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a satellite communications system (SCS), according to one embodiment.

FIGS. 2 and 3 are logic flow diagrams of methods of modal operation by a satellite and corresponding satellite access node (SAN), according to one embodiment.

FIG. 4 is a block diagram of first signal processing and transmit circuitry of a SAN, for operation in a first forward service mode that uses ground based beamforming, according to one embodiment.

FIG. 5 is a diagram of bandwidth utilization for a first type of feeder uplink signal, according to one embodiment.

FIG. 6 is a block diagram of second signal processing and transmit circuitry of a SAN, for operation in a second forward service mode that does not use ground based beamforming, according to one embodiment.

FIG. 7 is a diagram of bandwidth utilization for a second type of feeder uplink signal, according to one embodiment.

FIG. 8 is a block diagram of a first user link payload onboard a satellite, according to one embodiment.

FIGS. 9 and 10 are block diagrams of a second user link payload onboard a satellite, according to one embodiment.

FIG. 11 is a block diagram of mode control circuitry onboard a satellite, according to one embodiment.

FIGS. 12 and 13 are diagrams of example forward and return user beam arrangements in first forward and return service modes, according to one embodiment.

FIGS. 14 and 15 are diagrams of example forward and return user beam arrangements in second forward and return service modes, according to one embodiment.

### DETAILED DESCRIPTION

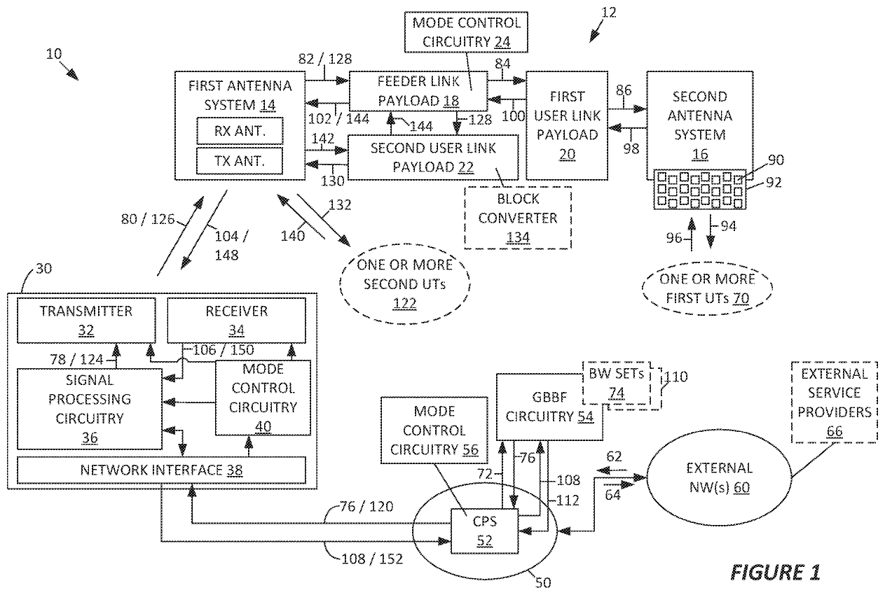

FIG. 1 illustrates a satellite communications system (SCS) 10 according to one embodiment. The SCS 10 includes one or more satellites 12, with each satellite 12 configured for serving one or more populations of user terminals (UTs). Only one satellite 12 appears in the diagram for simplicity and it includes a first antenna system 14, a second antenna system 16, a feeder link payload 18, a first user link payload 20, a second user link payload 22, and mode control circuitry 24.

One or more satellite access nodes (SANs) 30 reside in a ground network of the SCS 10, with one SAN 30 shown in the diagram for simplicity. Each SAN 30 includes a feeder link transmitter 32 and a feeder link receiver 34, along with corresponding signal processing circuitry 36—i.e., communications signal processing circuitry supporting communications signal transmission and reception. Further, each SAN 30 includes a network interface 38, and mode control circuitry 40.

Further items of interest in the ground network of the SCS 10 include a core network (CN) 50, which includes one or more computer servers configured as a communications processing system (CPS) 52. The CPS 52 includes or is associated with ground based beamforming (GBBF) circuitry 54 and mode control circuitry 56. The CPS 52 interfaces the SCS 10 to one or more external networks (NW(s)) 60, such as the Internet or other packet data networks (PDNs), and it is configured to receive incoming user traffic 62 from the external NW(s) 60 and transmit outgoing user traffic 64 to the external NW(s) 60. The incoming and outgoing user traffic 62 and 64 may involve one or more external service providers 66 that are reachable via the external NW(s) 60, and may comprise any one of or any mix of Internet Protocol (IP) packet flows, telecom traffic, voice, etc.

Among the several advantageous aspects of the SCS 10 is its multimodal operation, in which it operates with or without GBBF on a selective basis. Operating without GBBF offers more data bandwidth on the feeder link coupling the SAN 30 with the satellite 12. Thus, the operating mode(s) that do not use GBBF offer more of the overall feeder link bandwidth for use in transmitting user data, e.g., for supporting broadband or wideband data services to select UTs.

In one or more embodiments, the mode control circuitry 56 cooperates directly or indirectly with the mode control circuitry 40 in the SAN 30 and the mode control circuitry 24 in the satellite 16 to control the overall operating mode of the SCS 10, or at least the overall operating mode of the SAN 30 and the satellite 12 with respect to serving UTs. For example, the SCS 10 uses a first forward service mode on a selective basis, for serving a population of first UTs 70.

Although the geographic details are not shown in FIG. 1, the satellite 12 serves a population of first UTs 70 distributed over a satellite service area that is divided into a plurality of first forward user beam coverage areas. GBBF is used to form corresponding first forward user beams, each first forward user beam being a spot beam that illuminates a corresponding one of the first forward user beam coverage areas.

To understand such operations, the mode control circuitry 56 configures the CPS 52 for operation in the first forward service mode. Likewise, the mode control circuitry 40 configures the SAN 30 to operate in the first forward service mode, and the mode control circuitry 24 configures the satellite 12 to operate in the first forward service mode. The mode control may be triggered via control signaling propagated within the SCS 10 or may be triggered based on scheduling. For example, there is a defined service mode schedule followed by the CPS 52, the SAN 30, and satellite 12, in which they cooperatively operate in different service modes during different intervals, such as during different time slots in a recurring series of time slots.

In any case, user data 62 incoming to the SCS 10 for respective UTs 70 in the population of first UTs 70 is processed and formatted into a plurality of first forward beam signals 72, each first forward beam signal 72 conveying user traffic for those UTs 70 located in a corresponding one of the forward user beam coverage areas. In the first service mode, which makes use of GBBF, these first forward beam signals 72 are applied to the GBBF circuitry 54.

The GBBF circuitry 54 splits each first forward beam signal 72 into a duplicate set of signals, each duplicate signal corresponding to a respective antenna element in a phased array antenna included in the second antenna 16 onboard the satellite 12. The duplicate set of signals formed from each first forward beam signal 72 is weighted according to a corresponding beam weight (BW) set 74 comprising phase/amplitude weights corresponding to each antenna element in the phased array antenna included in the second antenna system 16 onboard the satellite 12.

Each BW set 74 is calculated such that transmission of the corresponding set of weighted duplicate signals from the phased array antenna will result in far-field formation of a forward user beam that illuminates a particular one of the first forward user beam coverage areas. For example, if there are 500 antenna elements in the phased array antenna of the second antenna system 16 that are to be used in the forward beamforming, each BW set 74 includes 500 complex weights, and each first forward beam signal 72 to be transmitted in the first service mode is split into 500 duplicate signals for weighting by a respective BW set 74 containing 500 corresponding weights.

With each set of weighted duplicate signals thus formed, combining circuitry in the GBBF 54 combines all such sets on a per-element basis, to form a set of combined element signals 76. That is, the weighted signals from all duplicate sets corresponding to a first antenna element of the phased array antenna are combined to form a first combined element signal to be transmitted from the first antenna element, the weighted signals from all duplicate sets corresponding to a second antenna element of the phased array antenna are combined to form a second combined element signal to be transmitted from the second antenna element, and so on.

The network interface 38 of the SAN 30, e.g., one or more Ethernet or other computer data network interfaces, receives the combined element signals 76. With the mode control circuitry 40 having configured the signal processing circuitry 36 for operation in the first forward service mode, the signal processing circuitry 36 outputs a set of forward element signals 78 that comprise or are derived from the combined element signals 76 on a one-to-one basis. For example, each forward element signal 78 is a RF or IF carrier modulated according to a respective one of the combined element signals 76.

The transmitter 32 as configured for operation in the first forward service mode transmits a first type of feeder uplink signal 80, based on stacking the forward element signals 78 in frequency—a form of frequency-domain multiplexing. Thus, the overall bandwidth of the first type of feeder uplink signal 80 may be understood as being divided into a plurality of spectral chunks, each chunk carrying a respective one of the forward element signals 78.

The first antenna system 14 onboard the satellite 12 includes a receive (RX) antenna, e.g., a reflector antenna or a receive array, which receives the first type of feeder uplink signal 80 and outputs a corresponding received feeder uplink signal 82. The feeder link payload 18 being configured for operation in the first forward service mode unstacks the forward element signals 78 from the received feeder uplink signal 82 and outputs a corresponding plurality of unstacked forward element signals 84 to the first user link payload 20. Here, the unstacked forward element signals 84 have a one-to-one correspondence with the forward element signals 78 that are stacked in frequency and may be understood as received or recovered versions of those signals.

The first user link payload 20, which comprises a bent-pipe payload in one or more embodiments, outputs a plurality of antenna element signals 86. Each antenna element signal 86 corresponds to a respective one among the plurality of unstacked forward element signals 84. For example, each antenna element signal 86 comprises an amplified and frequency-converted version of a respective one of the unstacked forward element signals 84. All antenna element signals 86 are at the same frequency, e.g., a selected downlink signal.

Each antenna element signal 86 is to be transmitted from a respective antenna element 90 of a phased array antenna 92 included in the second antenna system 16. Because of the weightings applied by the GBBF circuitry 54, simultaneous transmission of the plurality of antenna element signals 86 from the plurality of antenna elements 90 as a plurality of first downlink signals 94 results in the far field formation of the intended plurality of first forward user beams. Each one of the first forward user beams has a corresponding first forward user beam coverage area, with such details not illustrated in FIG. 1.

In a related first return service mode, the same phased array antenna 92 or another phased array antenna of the second antenna system 16 receives return uplink signals 96—user uplink signals—from transmitting ones among the population of first UTs 70. These return uplink signals 96 impinge on respective antenna elements of the phased array antenna used for receiving them, with each such antenna element outputting a corresponding one among a plurality of received antenna element signals 98. The first user link payload 20 couples this plurality of received antenna element signals 98 to the feeder link payload 18 as a plurality of return element signals 100, e.g., with filtering and amplification, and possible frequency shifting.

With the feeder link payload 18 configured for operation in the first return service mode, the feeder link payload 18 stacks the return element signals 100 in frequency to form an amplified outgoing signal 102. A transmit (TX) reflector or transmit array in the first antenna system 14 transmits the amplified outgoing signal 102 as a first type of feeder downlink signal 104.

The receiver 34 of the SAN 30 being configured for operation in the first return service mode receives the first type of feeder downlink signal 104 and outputs an unstacked set of return element signals 106, e.g., a set of RF or IF modulated carriers. The signal processing circuitry 36 outputs a corresponding set of return element signals 108, e.g., in the digital domain. The network interface 38 transmits the set of return element signals 108 to the CPS 52, which provides them to the GBBF circuitry 54, for GBBF in the return direction.

For GBBF in the return direction, the GBBF circuitry 54 maintains a BW set 110 for each first return user beam coverage area. The first return user beam coverage areas may be identical to the first forward user beam coverage areas, in terms of coverage and number, or they may be different.

Each return BW set 110 corresponds to a respective first return user beam having a corresponding first return user beam coverage area and it is used to weight the set of return element signals 108. That is, each return BW set 110 includes complex weights corresponding to respective antenna elements of the phased array onboard the satellite 12 used for reception of the first return uplink signals 96. Each return BW set 110 is applied to a respective copy of the set of return element signals 108, to form a corresponding weighted set that is combined to form a corresponding first return beam signal 112.

Thus, the GBBF circuitry 54 returns a plurality of first return beam signals 112, each one having an accentuated signal to noise ratio (SNR) for return uplink signals 96 originating from first UTs 70 that are located in the corresponding first return user beam coverage area. Thus, GBBF in the return direction can be understood as existing in the signal processing domain. The CPS 52 processes the first return beam signals 112 to recover the return user traffic, for output towards the external NW(s) 60 as outgoing user traffic 64.

In a second forward service mode, CPS 52 forms one or more second forward beam signals 120 for one or more second UTs 122. Here, “second” is a label for differentiation from “first.” For clarity, in this example framework, there are one or more UT's 70 that are served in the first forward service mode, which uses GBBF, and there are one or more UTs 122 that are served in the second forward service mode, which does not use GBBF.

As such, there may be one second UT 122 or multiple second UTs 122. While not shown, there are one or more second forward user beam coverage areas, which in one or more embodiments do not coincide with the first forward beam coverage areas associated with GBBF in the forward direction. The size and location(s) of the second forward user beam coverage areas may depend on the antenna type(s) and capabilities of the first antenna system 14. In one or more embodiments, the first antenna system 14 includes a transmit array and the satellite 12 applies beamforming weights, for formation of one or more second forward user beams, each illuminating a respective one of the one or more second forward user beam coverage areas. In one or more other embodiments, the first antenna system 14 includes one or more spot beam antennas that provide the one or more second forward user beams.

In either case, each second forward user beam coverage area may include one or more second UTs 122 to be served in the second forward service mode. In an example arrangement, there is one second forward beam signal 120 for each second forward user beam coverage area, with that second forward beam signal 120 conveying forward traffic for the one or more second UTs 122 located in the corresponding second forward user beam coverage area.

The SAN 30 receives the one or more second forward beam signals 120 via the network interface 38, and the signal processing circuitry 36 being configured for operation in the second forward service mode outputs a corresponding one or more second forward beam signals 124. Each second forward beam signal 124 is, for example, an analog domain representation of a corresponding second forward beam signal 120. The transmitter 32 transmits a second type of feeder uplink signal 126 conveying the one or more second forward beam signals 124.

Because the second forward service mode does not use GBBF, there is more feeder uplink bandwidth available for data transmission. Hence, the bandwidth of each second forward beam signal 120 output by the CPS 52 to the SAN 30 may have a much wider bandwidth than that of each first forward beam signal 72 output by the CPS 52 to the GBBF circuitry 54. In one embodiment or under some operating instructions, there is only one second forward beam signal 120 corresponding to a single second forward user beam coverage area that contains one or more second UTs 122. This single second forward beam signal 120 occupies up to the entire bandwidth used for the feeder uplink. Consequently, this second forward beam signal 120 provides a potentially much higher data bandwidth than is provided by the individual element signals comprised in the first type of feeder uplink signal 80, albeit without the advantages of GBBF.

To the extent that a single second forward beam signal 120 is used to serve more than one second UT 122, the traffic for the different UTs 122 may be multiplexed in time or multiplexed in the code domain. To the extent that there is more than one second forward beam signal 120 to be transmitted, the different second forward beam signals 120 are transmitted in different timeslots in one or more embodiments, allowing each one to occupy up to the full feeder uplink bandwidth. Alternatively, for simultaneous transmission of two or more second forward beam signals 120, the full feeder uplink bandwidth may be divided, with each second forward beam signal 120 transmitted in a different sub-band. While this sub-band approach means that each second forward beam signal 120 must have less than the full bandwidth of the feeder uplink, the bandwidth of each second forward beam signal 120 may nonetheless be much greater than the bandwidth of each first forward beam signal 72.

For example, assume a feeder uplink bandwidth of 5 GHz—e.g., using an optical feeder uplink. For operation in the first forward service mode with 1000 antenna elements 90 used for forming 1000 first forward user beams, each one of the 1000 forward element signals 78 has a bandwidth of 5 MHz, meaning that the first forward user beams formed have a signal bandwidth of 5 MHz. Now, assume the simultaneous transmission of 10 second forward beam signals 120 in the second forward service mode. The 5 GHz bandwidth of the feeder uplink allows each one of these 10 second forward beam signals 120 to occupy up to 500 MHz.

Thus, the first and second types of feeder uplink signals 80 and 126 may have the same overall bandwidth but the bandwidth consumed for GBBF in the first type of feeder uplink signal 80 is available for data transmission in the second type of feeder uplink signal 126. In at least one embodiment, then, the first forward service mode may be regarded as a narrowband service mode, at least in comparison to the second forward service mode.

As with the first type of feeder uplink signal 80, a RX reflector or array antenna of the first antenna system 14 receives the second type of feeder uplink signal 126 and outputs a corresponding received signal 128 to the feeder link payload 18. Based on being configured for operation in the second forward service mode, the feeder link payload 18 couples the received signal 128 to the second user link payload 22. The coupling may be direct, e.g., via switch controls in the mode control circuitry 24. The second user link payload 22 outputs a transmit signal 130 comprising a frequency-shifted version of the received signal 128, for transmission as one or more second user downlink signals 132. For example, the first antenna system 14 includes one or more mechanically steered reflectors or a transmit array used to transmit the one or more second user downlink signals 132 as one or more second forward user beams. Here, formation of the second forward user beam(s) relies on the satellite 12, rather than on GBBF.

In an example where the second type of feeder uplink signal 126 comprises two or more second forward beam signals 124 positioned in different frequency sub-bands, there is a corresponding second forward user beam formed or otherwise transmitted via the first antenna system 14 for each such second forward beam signal 124. In at least one embodiment, the second user link payload 22 is a bent-pipe payload that amplifies and frequency shifts the received signal 128, for retransmission. In at least one such embodiment, the second user link payload 22 contains a block converter 134 that applies a group or block frequency shift to the received signal 128, for retransmission.

In a related second return service mode, one or more ones of the one or more second UTs 122 transmit user uplink signals 140, referred to as second return uplink signals to distinguish them from the first return uplink signals 96 transmitted by respective ones among the population of first UTs 70. In an example embodiment, the bandwidth of each user uplink signal 140 is the same bandwidth or up to the same bandwidth of each second forward beam signal 120.

The first antenna system 14 includes a reflector or receive array for receiving the second return user uplink signal(s) 140, and outputs a corresponding received signal 142 to the second user link payload 22. The second user link payload 22 outputs a received signal 144 corresponding to the received signal 142. For example, the received signal 144 is a bent-pipe pass-through of the received signal 142, possibly with block frequency shifting, filtering, and amplification.

The feeder link payload 18 in one or more embodiments passes through the received signal 144 output by the second user link payload 22, for transmission as a second type of feeder downlink signal 148. The receiver 34 in the SAN 30 outputs a received signal 150, based on reception of the second type of feeder downlink signal 148, and the signal processing circuitry 36 outputs one or more return signals 152, which are recovered versions of the one or more second user uplink signals 140 transmitted by respective ones among the one or more second UTs 122. These return signals 152 may be digital domain streams and are transmitted back to the CPS 52 via the network interface 38. The CPS 52 processes the one return signals 152 to recover the user traffic conveyed in them, for output to the external NW(s) 60 as outgoing user traffic 64. GBBF processing via the GBBF circuitry 54 is not used in this second return service mode.

In at least one embodiment, the second user link payload 22 is a bent-pipe payload and it passes the received signal 142 to the feeder link payload 18 as said received signal 144, for transmission to the SAN 30 with no digital processing. For example, the second user link payload 22 in a bent-pipe embodiment only applies filtering, amplification, and frequency shifting via the block converter 134 to the received signal 142, to produce a corresponding received signal 144 that it outputs to the feeder link payload 18.

In one or more other embodiments, the second user link payload 22 is a processing payload that performs signal processing in the digital domain, based on demodulating/decoding signals in the forward and/or return directions. However, the use of onboard signal processing at the satellite 12 does not alter the basic modal operation as described above, although it may provide additional flexibility with respect to alternating between or switching modes.

Among the several advantages of the SCS 10 is that it provides for GBBF operation and non-GBBF operation without entirely forfeiting the complexity reductions gained at the satellite 12 by the use of GBBF. Particularly, the second user link payload 22 in one or more embodiments may be a simple bent-pipe signal path that adds little additional circuitry or other components to the satellite 12.

Further, the second forward and return service modes of operation advantageously reuse the first antenna system 14 for both feeder link and user link connectivity, with that same first antenna system 14 used for feeder link connectivity in the first forward and return service modes of operation.

Adding the second modes of forward and return service advantageously repurposes the first antenna system 14 and adds little additional transmit/receive circuitry onboard the satellite 12. That is, in an example embodiment, when operating in the first forward and return service modes, the first antenna system 14 of the satellite 12 receives the first type of feeder uplink signal 80 and transmits the first type of feeder downlink signal 104, and the second antenna system 16 provides for user downlink transmissions and user uplink transmissions. However, for operation in the second forward service mode, the RX components of the first antenna system 14 receive the second type of feeder uplink signal 126 and the TX components of the first antenna system 14 transmits the user downlink signal(s) 132. Similarly, for operation in the second return service mode, the RX components of the first antenna system 14 are used to receive the user uplink signal(s) 140 and the TX components of the first antenna system 14 are used to transmit the second type of feeder downlink signal 148.

Thus, in such an embodiment, the TX portion of the first antenna system 14 transmits user downlink signals in the second forward service mode and transmits feeder downlink signals in the second return service mode. Likewise, the RX portion of the first antenna system 14 receives feeder uplink signals in the second forward service mode and receives user uplink signals in the second return service mode. The second antenna system 16 is not used for the user link in these second forward and return service modes.

Similar efficiency advantages are seen in the SAN 30, wherein the different types of feeder uplink and downlink signals may be transmitted and received based on reusing the same antenna(s) and by reusing some or all of the same transmit/receive circuitry and signal processing in the SAN 30. In some sense, the second forward and return service modes are piggybacked onto at least some of the same hardware used for the first forward and return service modes, with relatively simple mode control circuitry providing for mode selection.

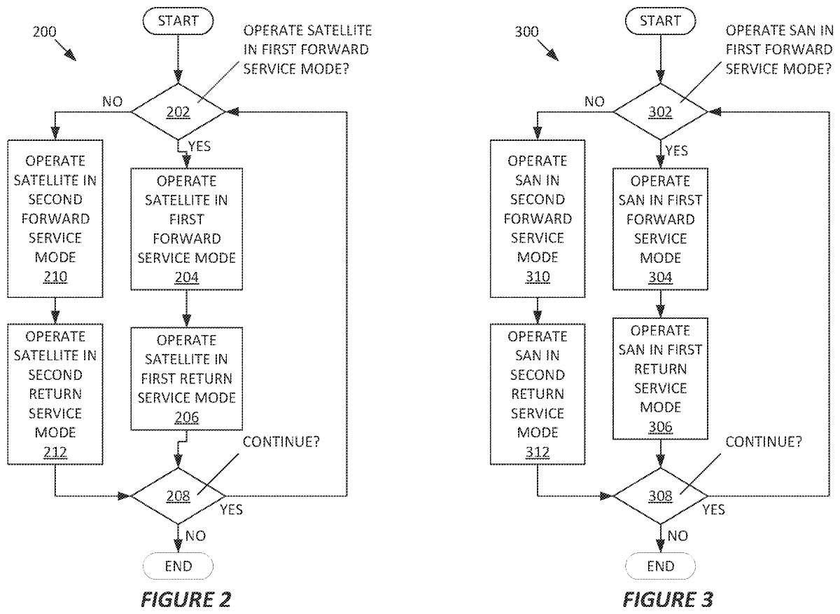

FIG. 2 illustrates a method 200 of operation by an example multimodal satellite 12 consistent with the above examples. The method 200 includes logically checking (Block 202) whether the satellite 12 is to operate in the first forward service mode as described above. Checking involves evaluating control signaling received from the SAN 30, for example, or referencing scheduling information loaded in a memory of the satellite 12, for example.

If “YES,” processing continues with the satellite 12 operating in the first forward service mode (Block 204) and, in conjunction, operating in the first return service mode (Block 206) as described above. From there, if there are no faults or other stoppage commands or events, processing returns to the logical check of Block 202—see the YES branch from decision block 208. If method 200 is to stop or be suspended—see the NO branch from decision Block 208—the method 200 stops.

If the satellite 12 is to operate in the second forward service mode—NO from Block 202—processing continues with the satellite 12 operating in the second forward service mode (Block 210) as described above, and, in conjunction, operating in the second return service mode (Block 212) as described above.

In one or more embodiments or under certain operating conditions, the method 200 includes the satellite 12 operating in the first forward service mode and the first return service mode on a half-duplex (alternating) basis. In one or more other embodiments or under certain other operating conditions, the satellite 12 operates in the first forward service mode and the first return service mode on a full-duplex (simultaneous) basis.

In one or more embodiments or under certain operating conditions, the method 200 includes the satellite 12 operating in the second forward service mode and the second return service mode on a half-duplex basis. In one or more other embodiments or under certain other operating conditions, the satellite 12 operates in the second forward service mode and the second return service mode on a full-duplex basis.

FIG. 3 illustrates a method 300 of operation by the SAN 30, which directly complements the method 200. The method 300 begins with the SAN 30 determining whether to operate in the first forward service mode. If so (YES from Block 302), the SAN 30 operates in the first forward service mode (Block 304) as described above for the SAN 30 and, in conjunction, the SAN 30 operates in the first return service mode (Block 306) as described above. The method 300 may be stopped or suspended (NO from Block 308) or may repeat (YES from Block 308). With repetition, processing returns to Block 302 for the first-mode/second-mode check.

If the SAN 30 is to operate in the second forward service mode (NO from Block 302), the SAN 30 changes from operating in the first forward service mode to operating in the second forward service mode (Block 310), as described above. In conjunction with operating in the second forward service mode, the SAN 30 operates in the second return service mode (Bock 312) as described above. Again, the first forward/return service modes and the second forward/return service modes at the SAN 30 may be full duplex operation or half duplex operation.

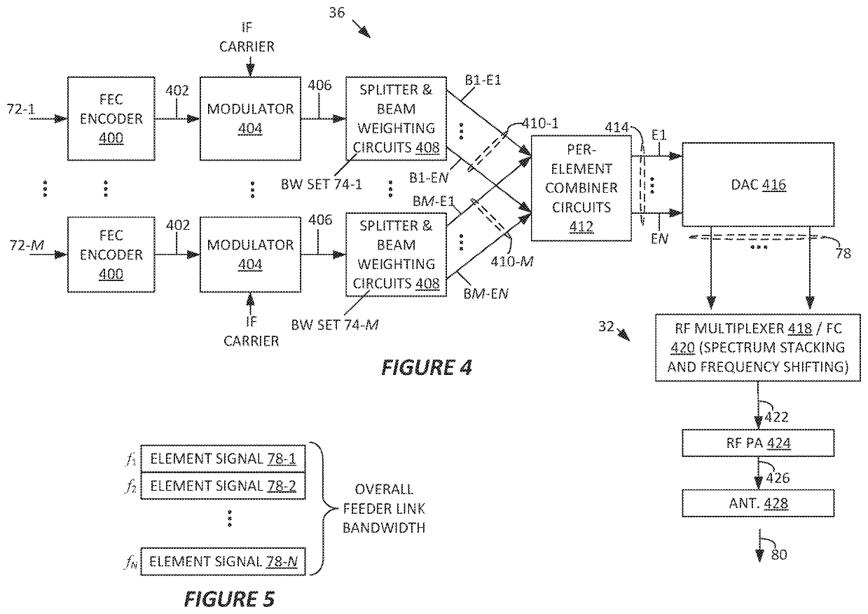

FIG. 4 illustrates example details for the signal processing circuitry 36 and transmitter 32 of the SAN 30, for supporting operation in the first forward service mode. Assuming the formation of M first forward user beams using N antenna elements 90 of the phased array antenna 92 onboard the satellite 12, there are M first forward beam signals 72, shown as 72-1 through 72-M. Here, M is an integer equal to or less than the integer N.

Forward error correction (FEC) encoders 400 operate on the first forward beam signals 72 to produce corresponding encoded signals 402. Each encoded signal 402 serves as an input to a respective modulator 404, which modulates an IF carrier responsive to the input encoded signal 402. Note that these operations are performed in the digital domain, in one or more embodiments, such that the IF carriers are digital streams, as are the first forward beam signals 72.

Each resulting modulated signal 406 is split into a set of N duplicate signals via respective splitter and beam weighting circuitry 408. Each duplicate signal corresponds to a respective one among the N antenna elements 90 to be used for beamforming of the first forward user beams—see the phased array antenna 92 that is included in the second antenna system 16 of the satellite 12.

The N duplicate signals are weighted by a corresponding BW set 74, as described earlier, to produce a corresponding set of weighted beam element signals 410. That is, for each one of the M first forward beam signal 72, there is a corresponding set of N weighted beam element signals 410, with the corresponding BW set 74 being calculated for formation of a first forward user beam oriented on the first forward beam coverage area containing UTs 70 targeted by the user traffic conveyed by the first forward beam signal 72. Thus, in the depicted example, there are M sets of weighted beam element signals 410, for first forward user beams B1 through BM, with each such set including element signals E1 through EN, corresponding to elements E1 through EN of the phased array antenna 92.

Per element combiner circuits 412 combine the M sets of weighted beam element signals 410 on a per element basis, as described earlier, to form a set of N combined forward element signals 414, each such combined forward element signal being the linear combination of all weighted duplicate beam element signals 410 targeted for transmission from the same antenna element 90 of the phased array antenna 92. A digital-to-analog converter (DAC) 416 converts the N combined forward element signals 414 to the analog domain, with these analog domain signals being the forward element signals 78 mentioned in the context of FIG. 1.

A RF multiplexer 418 and frequency converter 420 perform frequency stacking of the forward element signals 78 within the feeder uplink spectrum, to form a multiplexed signal 422, which is amplified by a RF power amplifier 424 to produce an amplified signal 426 that is emitted from an antenna 428 of the SAN 30 as the first type of feeder uplink signal. Equivalently, the RF multiplexer 418 may be an optical multiplexer, with the first type of feeder uplink signal 80 being a multiplexed optical signal in which the respective first forward element signals 78 are conveyed via respective optical channel signals according to wavelength division multiplexing (WDM) in the optical domain. In either case, FIG. 5 illustrates an example stacking arrangement in which each forward element signal 78 occupies a different spectral chunk within the overall feeder link bandwidth.

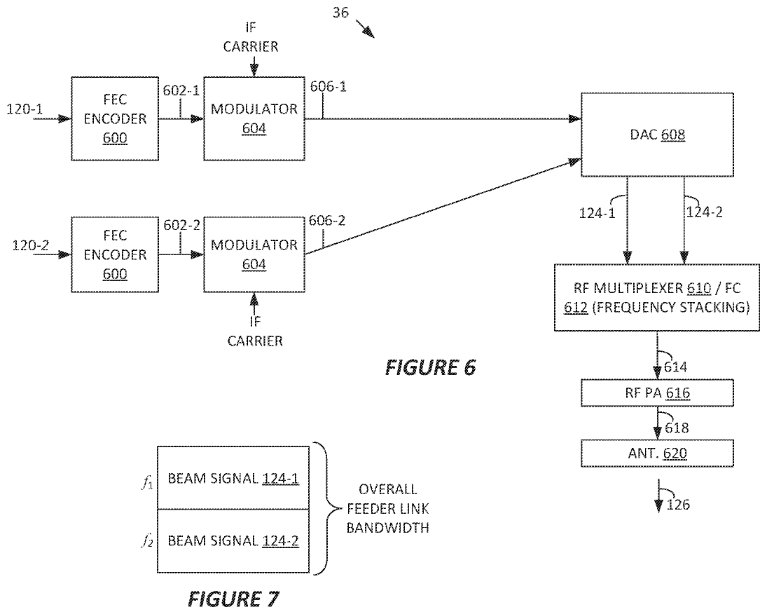

FIG. 6 illustrates example details of the SAN 30 for operation in the second forward service mode, and in the example context where the second forward service mode involves the simultaneous transmission of two second forward beam signals 120, shown as second forward beam signals 120-1 and 120-2. Here, the simultaneous transmission is based on frequency multiplexing but code multiplexing may be used as an alternative. It may be that with code multiplexing, the different UTs 122 served by the different second forward beam signals 120 may be located in the same geographic region—e.g., the second forward user beams corresponding to the different second forward beam signals 120 have the same coverage area. Further, more than one second forward beam signal 120 may be transmitted based on time multiplexing, rather than code or frequency domain multiplexing.

The circuitry shown in FIG. 6 may be additional with respect to that shown in FIG. 4, or all or at least some of the circuitry shown in FIG. 4 may be reused. That is, some or all of the transmit signal path circuitry and components, including especially power amplifiers and antennas, that are used in the SAN 30 for transmission of the first type of feeder uplink signal 80 may be reused for transmission of the second type of feeder uplink signal 126. However, it will be understood that any such reused circuitry or components must accommodate the potentially much wider bandwidth of the second forward beam signals 120 as compared to the bandwidth of the first forward beam signals 72.

Each second forward beam signal 120-1 and 120-2 is encoded via a respective FEC encoder 600 and each resulting encoded signal 602-1 and 602-2 feeds a respective modulator 604. The resulting modulated signals 606-1 and 606-2 feed into a DAC 608, which converts them into the analog signal domain, to produce respective second forward beam signals 124-1 and 124-2, such as suggested in FIG. 1.

A RF multiplexer 610/frequency converter 612 stack the two second forward beam signals 124-1 and 124-2 to form a multiplexed signal 614 within the feeder uplink spectrum, and a RF PA 616 amplifies the multiplexed signal 614 to produce an amplified signal 618. An antenna 620 of the SAN 30 transmits the amplified signal 618 as the second type of feeder uplink signal 126. As noted, the multiplexing, amplification, and, especially, the transmit antenna, used for transmission of the second type of feeder uplink signal 126 may be the same as used for transmission of the first type of feeder uplink signal 80.

Also, as with first type of feeder uplink signal 80, the second type of feeder uplink signal 126 may be in the optical domain rather than in the RF domain. In either case, FIG. 7 illustrates conveyance of the two second forward beam signals 124-1 and 124-2 within the overall feeder uplink bandwidth. In the example, each such beam signal occupies half of the feeder uplink bandwidth, at a respective center frequency f₁ or f₂. Notably, when transmitting two or more second forward beam signals 124 at the same time, the respective allocations of feeder uplink bandwidth need not be uniform—e.g., different ones of the second forward beam signals 124 may have different signal bandwidths.

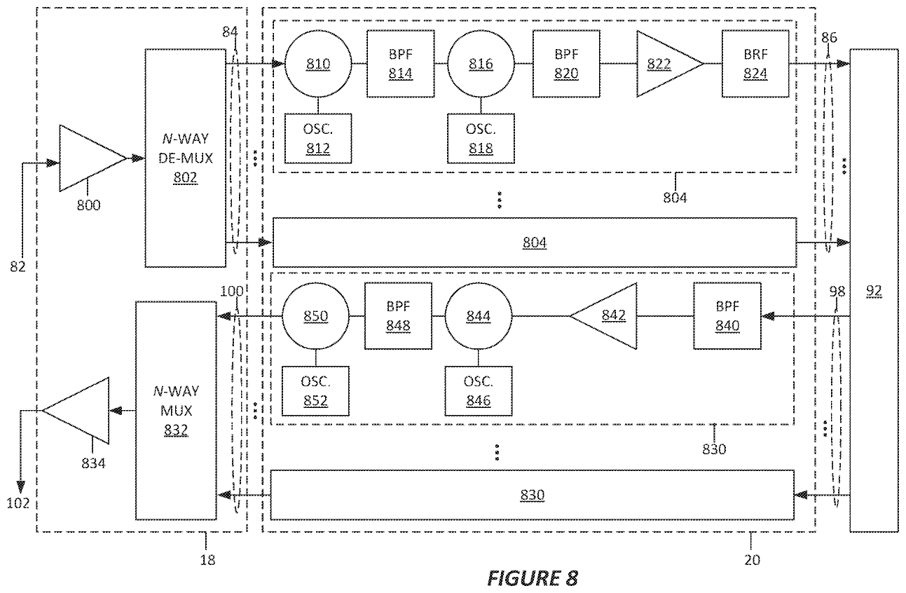

FIG. 8 illustrates a bent-pipe embodiment of the feeder link payload 18 and the first user link payload 20 onboard the satellite 12, for support of the first forward and return service modes. The first antenna system 14 provides the received feeder uplink signal 82 to the feeder link payload 18, which includes a low noise amplifier (LNA) 800 and a N-way demultiplexer 802 that outputs the unstacked forward element signals 84 described above. Each such unstacked forward element signal 84 is input to a respective bent-pipe forward transponder 804, which outputs a corresponding one of the antenna element signals 86 described above.

Each bent-pipe forward transponder 804 comprises a non-processed electrical signal path that provides filtering, power amplification, and frequency translation. See mixer 810 and its associated oscillator 812, bandpass filter 814, which may comprise a surface acoustic wave filter, mixer 816 and its associated oscillator 818, bandpass filter 820, power amplifier 822, and band rejection filter 824.

For operation in the first return service mode, the phased array antenna 92 outputs the plurality of received antenna element signals 98 described above, with each such signal being input to a corresponding bent-pipe return transponder 830. The plurality of bent-pipe return transponders 830 output the plurality of return element signals 100 described above. A N-way multiplexer 832 performs frequency stacking of the plurality of return element signals 100 to form a multiplexed signal that is amplified by a power amplifier 834 to form the amplified outgoing signal 102 that is described above.

In the example depiction, each bent-pipe return transponder 830 provides for filtering, frequency translation, and low noise amplification. Correspondingly, each bent-pipe return transponder 830 comprises a bandpass filter 840, a low noise amplifier 842, a mixer 844 and its associated oscillator 846, a bandpass filter 848, and a mixer 850 and its associated local oscillator 852.

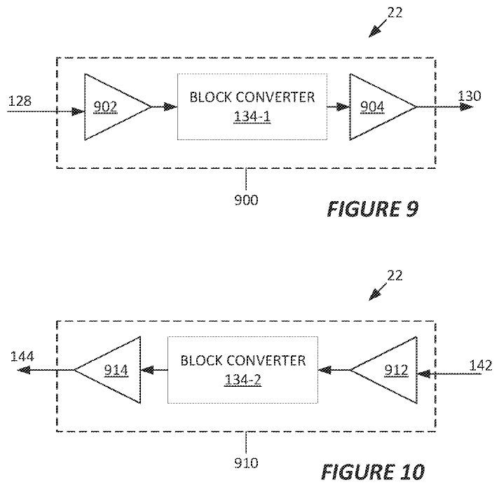

FIGS. 9 and 10 illustrate the second user link payload 22 according to an example bent-pipe implementation. In the second forward service mode, the received signal 128 is input to a bent-pipe forward transponder 900, which includes a low noise amplifier 902 and the block frequency converter 134 mentioned earlier, which may include a forward block frequency converter 134-1. Further, the bent-pipe forward transponder 900 includes a power amplifier 904, which outputs the transmit signal 130 discussed above.

The second user link payload 22 in this embodiment further includes a return bent-pipe transponder 910. The received signal 142 described above is input to a low noise amplifier 912, which feeds into a return block frequency converter 134-2. The frequency-converted output is applied to a power amplifier 914, to produce the received signal 144 described above.

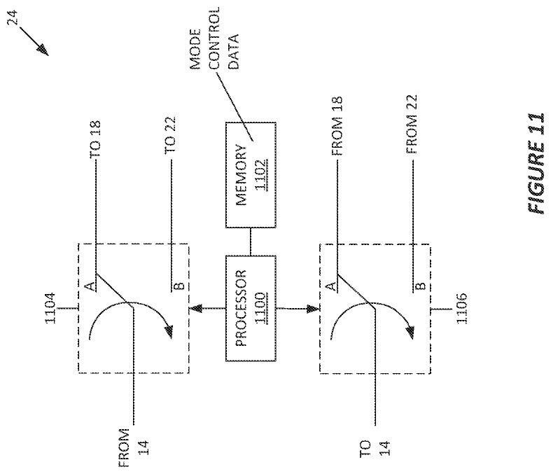

FIG. 11 illustrates the mode control circuitry 24 onboard the satellite 12 according to an example embodiment. The mode control circuitry 24 comprises, for example, a processor 1100 and associated memory 1102. For example, the memory 1102 stores mode control data, such as a mode switching schedule, and the processor 1100 controls the operating mode of the satellite 12 according to the stored mode control data, or according to live control signaling incoming to the satellite 12 from the SAN 30. The processor 1100 comprises, for example, a microprocessor that is specially adapted to control the operating mode of the satellite 12, based on the execution of computer program instructions stored in the memory 1102 or in other computer readable media onboard the satellite 12.

The mode control circuitry 24 in the example arrangement further includes RF switches 1104 and 1106. The RF switch 1104 controls whether a receive reflector or array of the first antenna system provides the received feeder uplink signal to the feeder link payload 18 or to the second user link payload 22. In the first forward service mode, the first antenna system 14 receives the first type of feeder uplink signal 80 and provides the corresponding received feeder uplink signal 82 to the feeder link payload 18 via the switch 1104 in position “A.” In the second forward service mode, the first antenna system 14 receives the second type of feeder uplink signal 126 and provides the corresponding received signal 128 to the second user link payload 22 via the switch 1104 in position “B.” Equivalently, this second mode may be understood as a pass-through mode for the feeder link payload 18.

The RF switch 1106 controls selection between operation in the first return service mode or in the second return service mode. In the first return service mode, the RF switch 1106 is in position “A,” such that the feeder link payload 18 provides the amplified outgoing signal 102 to the first antenna system 14, for transmission as the first type of feeder downlink signal 104. In the second return service mode, the RF switch 1106 is in position “B,” such that the second user link payload 22 provides the signal 144 to a transmit reflector or array of the first antenna system 14, for transmission as the second type of feeder downlink signal 148. Equivalently, the feeder link payload 18 may be regarded as providing pass-through connectivity for the signal 144 in the second mode of return service, for transmission from the first antenna system 14.

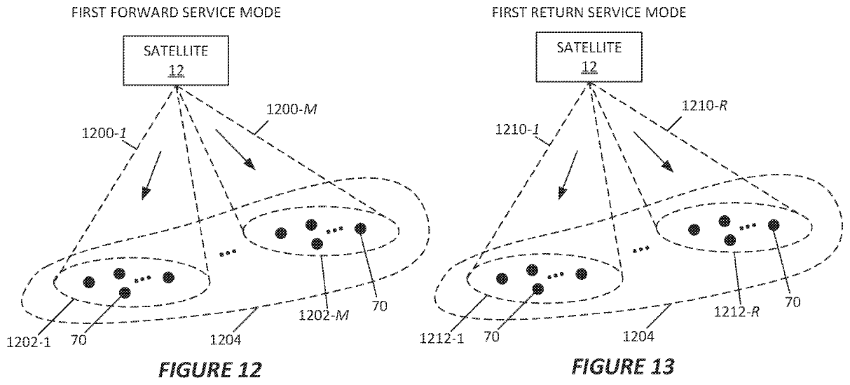

FIG. 12 illustrates an example set of M forward user beams 1200 formed by the satellite 12 during operation in the first forward service mode, with the beams shown as forward user beams 1200-1 through 1200-M. Each forward user beam 1200 corresponds to a respective one of the forward beam signals 72 introduced in FIG. 1 and conveys traffic for UTs 70 located in a corresponding forward user beam coverage area 1202, e.g., the forward user beam 1200-1 serves UTs 70 located in the forward user beam coverage area 1202-1, and so on. These forward user beam coverage areas 1202 subdivide a larger satellite service area 1204.

FIG. 13 illustrates an example set of R return user beams 1210 formed by the satellite 12 during operation in the first return service mode, with the beam shown as return user beams 1210-1 through 1210-R. As noted, these return user beams 1210 do not exist in physical space in one or more embodiments, but rather are formed in the processing domain within the GBBF circuitry 54 introduced in FIG. 1, and their illustration here is for explanatory purposes. Each return user beam 1210 has a corresponding return user beam coverage area 1212, shown as return user beam coverage areas 1212-1 through 1212-R. The integer value of R may or may not match M, and the return user beams 1210 may or may not match the forward user beams 1200 in terms of size, orientation, and corresponding coverage.

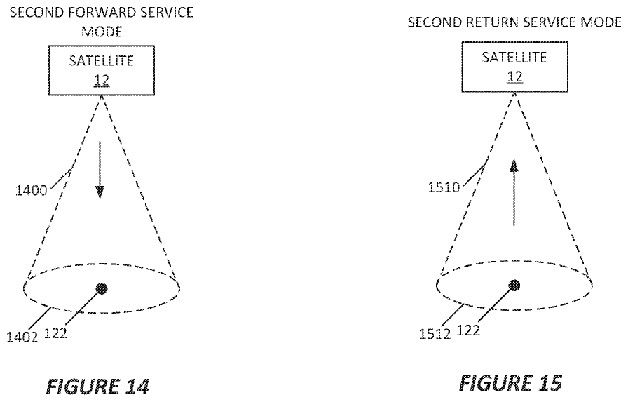

FIG. 14 illustrates example operation of the satellite 12 in the second forward service mode, in a scenario where it transmits a single second forward user beam 1400 for a single UT 122, which is located in a corresponding coverage area 1402 of the second forward user beam 1400. In some embodiments or in some operational scenarios, there is no overlap between any second forward user beam coverage area 1402 and any first forward user beam coverage area 1202. In at least one such example case, the second forward user beam coverage area 1402 comprises or is subsumed in a SAN coverage area of the satellite 12.

FIG. 15 illustrates example operation of the satellite 12 in the second return service mode, in a scenario where it receives return uplink signals from the same single UT 122 illustrated in FIG. 14, using a single second return user beam 1510 with a corresponding return user beam coverage area 1512. The return user beam 1510 and return user beam coverage area 1512 may substantially match the forward user beam 1400 and forward user beam coverage area 1402.

In a half-duplex arrangement, FIG. 14 may be understood as depicting satellite operation for a first interval, with FIG. 15 depicting satellite operation at a different, second interval. Of course, there may be more than one UT 122 served by the forward user beam 1400 and the same holds true for the return user beam 1510.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-26. (canceled)

27. A method of operation by a satellite in a satellite communications system, the method comprising selectively operating in either a first forward service or a second forward service mode, wherein:
the first forward service mode comprises:
receiving, via a first antenna system of the satellite, a first type of feeder uplink signal comprising a plurality of forward element signals stacked in frequency and corresponding to antenna elements in a phased array antenna included in a second antenna system of the satellite, the plurality of forward element signals weighted such that simultaneous transmission of the plurality of forward element signals as first user downlink signals from the phased array antenna results in far field formation of one or more first forward user beams, each first forward user beam having a corresponding first forward user beam coverage area and conveying traffic for one or more first user terminals that are in a population of first user terminals and are located in the corresponding first forward user beam coverage area;
unstacking the plurality of forward element signals to a same downlink frequency via a feeder link payload of the satellite; and
coupling the unstacked plurality of forward element signals to the phased array antenna via a first user link payload of the satellite, for transmission from the phased array antenna as the first user downlink signals and the resulting formation of the one or more first forward user beams; and
the second forward service mode comprises:
receiving, via the first antenna system of the satellite, a second type of feeder uplink signal comprising one or more forward beam signals; and
coupling the one or more forward beam signals to the first antenna system via a second user link payload of the satellite, for transmission from the first antenna system as one or more second user downlink signals, each second user downlink signal transmitted as a corresponding second forward user beam having a corresponding second forward user beam coverage area and conveying traffic for one or more second user terminals that are in a population of second user terminals and are located in the corresponding second forward user beam coverage area.

28. The method according to claim 27, wherein the first and second type of feeder uplink signals occupy a same first bandwidth in a same first spectrum, wherein the one or more second forward user beams are at signal frequencies in the first spectrum, and wherein the one or more first forward user beams are at signal frequencies in a second spectrum.

29. The method according to claim 28, wherein the first spectrum is E-band spectrum and the second spectrum is L-band or S-band spectrum.

30. The method according to claim 27, wherein a signal bandwidth of each of the one or more first forward user beams is a function of a feeder uplink bandwidth and the number of forward element signals comprised in the plurality of forward element signals conveyed by the first type of feeder uplink signal, and wherein a signal bandwidth of each of the one or more second forward user beams is a function of the feeder uplink bandwidth and the number of forward beam signals simultaneously conveyed in the second type of feeder uplink signal.

31. The method according to claim 30, wherein the signal bandwidth of each of the one or more first forward user beams is less than 10 MHz, and the signal bandwidth of each of the one or more second forward user beams is greater than 100 MHz.

32. The method according to claim 27 wherein the second user link payload includes a block frequency converter that applies a defined frequency shift to the second type of feeder uplink signal, and wherein the one or more second forward user beams are a bent-pipe retransmission of the one or more forward beam signals conveyed in the second type of feeder uplink signal.

33. The method according to claim 27, wherein the first user link payload comprises a first bent-pipe user link payload, for bent-pipe retransmission of the plurality of forward element signals, and second user link payload comprises a second bent-pipe user link payload for bent-pipe retransmission of the one or more forward beam signals.

34. The method according to claim 27, further comprising operating in a first return service mode in conjunction with operating in the first forward service mode, the first return service mode comprising:
receiving a plurality of first return uplink signals transmitted by respective first user terminals in the population of first user terminals, the respective first user terminals operating in one or more respective first return user beam coverage areas and the plurality of first return uplink signals received at the same or another phased array antenna in the second antenna system as a corresponding plurality of received element signals;
coupling, via the first user link payload, the plurality of received element signals to the feeder link payload as a plurality of return element signals;
stacking, via the feeder link payload, the plurality of return element signals in frequency; and
transmitting, via the first antenna system, the stacked plurality of return element signals as a first type of feeder downlink signal.

35. The method according to claim 27, further comprising operating in a second return service mode in conjunction with operating in the second forward service mode, the second return service mode comprising:
receiving, via the first antenna system, one or more second return uplink signals transmitted by respective ones among the one or more second user terminals operating in one or more second return user beam coverage areas;
for each of the one or more second return user beam coverage areas, coupling, via the second user link payload, the correspondingly received second return uplink signal or signals to the feeder link payload as a return beam signal;
forming, via the feeder link payload a second type of feeder downlink signal comprising the one or more return beam signals; and
transmitting the second type of feeder downlink signal via the first antenna system.

36. The method according to claim 35, wherein the method includes operating in the second forward service mode and the second return service mode on a half-duplex basis, such that at one or more scheduled times, the satellite operates in the second forward service mode.

37. The method according to claim 27, wherein the first antenna system comprises a receive phased array antenna and a transmit phased array antenna, and wherein operating in the second forward service mode comprises performing onboard receive beamforming for directional reception of the second type of feeder uplink signal from a serving satellite access node (SAN) and performing onboard transmit beamforming for directional transmission of the one or more corresponding second forward user beams.

38. The method according to claim 37, wherein operating in the first forward service mode comprises performing onboard receive beamforming for directional reception of the first type of feeder uplink signal from the SAN.

39. The method according to claim 27, wherein the first antenna system comprises mechanically steered receive and transmit antennas, and wherein operating in the second forward service mode comprises orienting the mechanically steered receive antenna for directional reception of the second type of feeder uplink signal from a serving satellite access node (SAN) and orienting the mechanically steered transmit antenna for directional transmission of the one or more corresponding second forward user beams.

40. The method according to claim 27, further comprising changing between the first and second forward service modes responsive to commands received from a ground network of the satellite communications system.

41. The method according to claim 27, further comprising changing between the first and second forward service modes responsive to scheduling information received from a ground network of the satellite communications system.
